(19) United States
(12) Patent Application Publication
(10) Pub. No.: US 2012/0061158 A1
(43) Pub. Date: Mar. 15, 2012

(54) Working vehicle

(76) Inventor: Takashi Gotou, Osaka (JP)

(21) Appl. No.: 12/927,002

(22) Filed: Nov. 4, 2010

(30) Foreign Application Priority Data
Sep. 9, 2010 (JP) 2010-201617

(51) Int. Cl. B60K 1/00; B60K 8/00

(52) U.S. Cl. 180/65.1; 180/54.1

(57) ABSTRACT

The invention intends to provide a working vehicle which can easily achieve an improvement of a traveling stability, a reduction of a manufacturing cost, an improvement of a shift performance, a reservation of a lift space of a mid mount ground working machine 25, and the like. In a working vehicle in which ground working machines 25, 31 are installed to a traveling machine body 2 which is supported by front wheels 6 and rear wheels 7 so as to freely travel, a transmission 8 is arranged in a front portion of the traveling machine body 2 to which a prime mover 5 is mounted, whereby a power of the prime mover 5 is transmitted to the front wheels 6 via the transmission 8.

### CROSS-REFERENCE TO RELATED APPLICATION

This application is based on application No. 2010-201617 filed in Japan, the entire content of which is hereby incorporated by reference.

### BACKGROUND OF THE INVENTION

1. Field of the Invention

The present invention relates to a working vehicle such as a tractor or the like carrying out a ground work such as a civil engineering work or a farm work, by detachably installing, for example, a civil engineering working machine such as a front loader or the like, or a farm working machine such as a rotary tiller working machine or the like.

2. Related Art

Conventionally, there has been a tractor in which a front loader machine or the like is installed to a traveling machine body which is supported by front wheels and rear wheels so as to freely travel. An example of such a tractor is disclosed in Japanese Unexamined Patent Publication No. 2007-112233.

In the prior art mentioned above, an engine is provided in a front portion of a traveling machine body, a transmission case is provided in a rear portion of the traveling machine body, and a driving force is transmitted to rear wheels from the engine via the transmission case. In the case that the front loader is installed to the front portion of the traveling machine body, a forward side of the traveling machine body becomes heavier than a rearward side. Accordingly, the traveling machine body comes to a forward tilted attitude by a bucket load, and there is a problem on a traveling performance such as a lack of a grounding pressure of the rear wheels or the like. Accordingly, there is such a problem that it is necessary to improve a balance between front and rear of the traveling machine body, by mounting a balancing weight (a rotary tiller working machine or the like) to the rear portion of the traveling machine body. Further, in the case that a lawn mower is mounted between the front wheels and the rear wheels, since a driving mechanism transmitting the driving force to the transmission case from the engine is arranged above the lawn mower, there is such a problem that a lifting height of the lawn mower is limited by the driving mechanism, or the like.

Accordingly, the present invention intends to provide a working vehicle to which an improvement is applied by making a study of these actual conditions.

### SUMMARY OF INVENTION

In order to achieve the object mentioned above, in accordance with a first aspect of the present invention, there is provided a working vehicle comprising:

a ground working machine being installed to a traveling machine body which is supported by front wheels and rear wheels so as to freely travel,

wherein a transmission is arranged in a front portion of the traveling machine body to which a prime mover is mounted, whereby a power of the prime mover is transmitted to the front wheels via the transmission.

In accordance with a second aspect of the present invention, there is provided a working vehicle as recited in the first aspect, wherein an engine serving as the prime mover is mounted to the front portion of the traveling machine body.

In accordance with a third aspect of the present invention, there is provided a working vehicle as recited in the first aspect, further comprising:

a traveling hydraulic pump and a traveling hydraulic motor which serve as the transmission,

wherein the traveling hydraulic pump is arranged in the traveling machine body, the traveling hydraulic motor is arranged in a front axle case by which the front wheels are supported, and the front wheels steered by a control handle is driven by the traveling hydraulic motor.

In accordance with a fourth aspect of the present invention, there is provided a working vehicle as recited in the first aspect, further comprising:

a main shift operation device mainly shift controlling the traveling hydraulic pump; and

an auxiliary shift operation device accessorily shift controlling the traveling hydraulic motor.

In accordance with a fifth aspect of the present invention, there is provided a working vehicle as recited in the first aspect, wherein an electric motor serving as the prime mover is mounted to the front portion of the traveling machine body.

### BRIEF DESCRIPTION OF THE DRAWINGS

FIG. 1 is a side view of an outer appearance of a tractor according to a first embodiment of the present invention.

FIG. 2 is a plan view of the same.

FIG. 3 is a side explanatory view of the same.

FIG. 4 is a plan explanatory view of a front wheel portion of the same.

FIG. 5 is a view of a drive system of the same.

FIG. 6 is a side view of an outer appearance of a tractor according to a second embodiment of the present invention.

FIG. 7 is a plan view of the same.

FIG. 8 is a side explanatory view of the same.

FIG. 9 is a plan explanatory view of a front wheel portion of the same.

FIG. 10 is a view of a drive system of the same.

FIG. 11 is a view of a drive system of a tractor according to a third embodiment of the present invention.

FIG. 12 is a side explanatory view showing a modified structure of FIG. 3.

### DESCRIPTION OF THE PREFERRED EMBODIMENTS

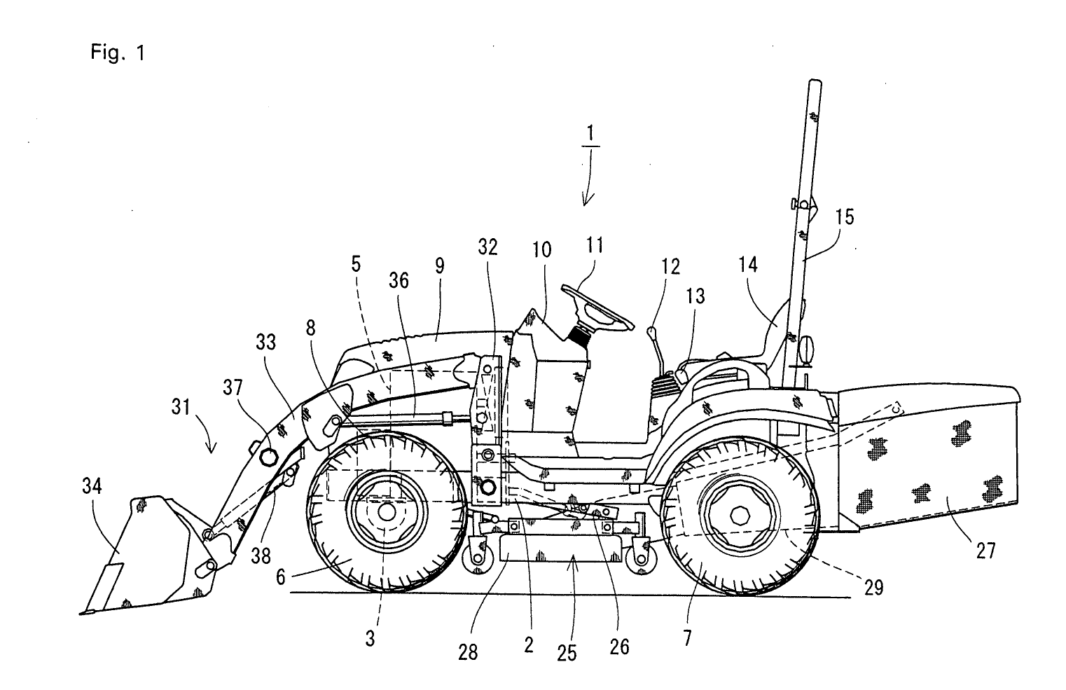

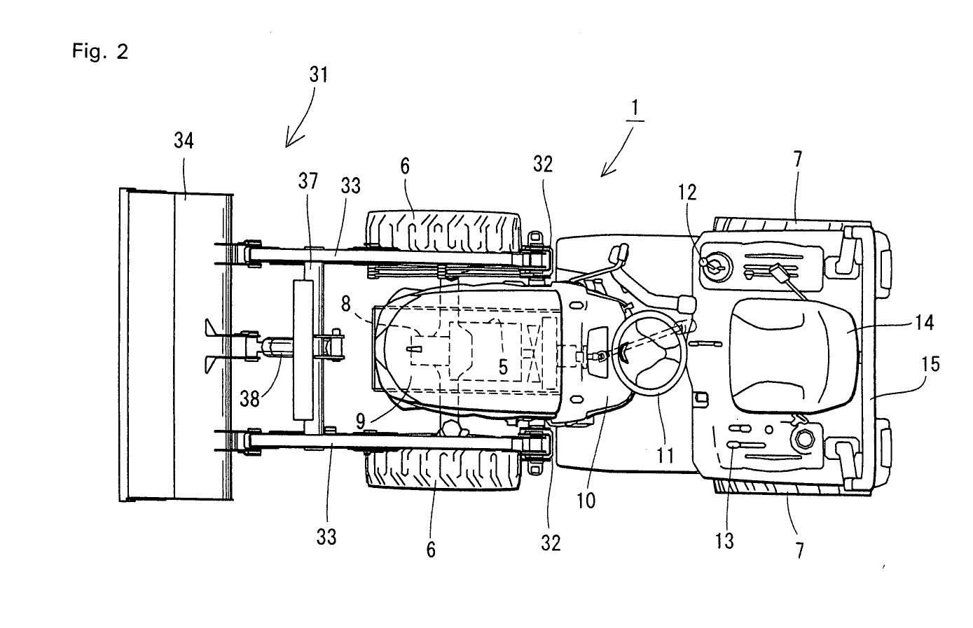

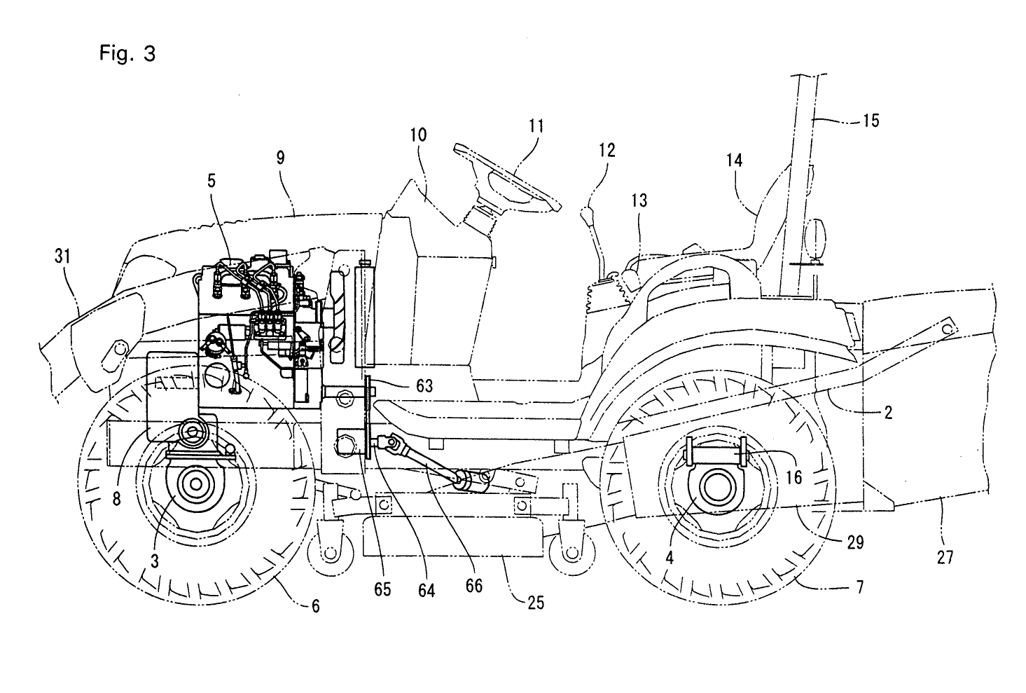

A description will be in detail given below of a first embodiment of the present invention on the basis of the accompanying drawings, with reference to FIGS. 1 to 5. FIG. 1 is a side view of an outer appearance of a tractor 1, FIG. 2 is a plan view of the same, and FIG. 3 is a side explanatory view of the same. A left side in a forward direction of the tractor 1 is called simply as a left side, and a right side in the forward direction is called simply as a right side in the same manner. A pair of right and left front wheels 6 are supported to a front portion of a vehicle body frame 2 of the tractor 1 via a front axle case 3. A pair of right and left rear wheels 7 are supported to a rear portion of the vehicle body frame 2 of the tractor 1 via a rear axle case 4.

An engine 5 serving as a prime mover is mounted to a front portion of the vehicle body frame 2. A transmission case 8 is additionally provided in the engine 5. The tractor 1 is structured such as to travel forward and backward by transmitting a driving force from the engine 5 to the front wheels 6 via the transmission case 8. The engine 5 is covered by a hood 9.

A control column portion 10 having a control handle 11 is arranged in a rear portion of an upper surface of the hood 9. In this case, if the control handle 11 is rotationally operated, the right and left front wheels 6 are steered in correspondence to an amount of operation (an amount of rotation) thereof. A control seat 14 is provided in an upper surface of the rear portion of the vehicle body frame 2. A main shift lever 12 is arranged in a left side of the control seat 14. An auxiliary shift lever 13 is arranged in a left side of the control seat 14. In this case, a rear side of the control seat 14 is provided with a rollover protective structure frame 15 for protecting an operator at a time when the tractor 1 inverses.

The transmission case 8 for shifting the power from the engine 5 so as to transmit to the front wheels 6 and the rear wheels 7 is arranged in an upper portion of the front axle case 3 in the front portion of the vehicle body frame 2. The front axle case 3 is installed to the transmission case 8 in such a manner as to protrude in right and left outward directions. The engine 5, the front axle case 3, and the transmission case 8 are firmly attached integrally. The right and left rear wheels 7 are rotatably attached to the right and left end sides of the rear axle case 4. A center portion of the right and left width of the rear axle case 4 is connected to the vehicle body frame 2 via a rolling shaft 16, the rear axle case 4 rotates around the rolling shaft 16, and the right and left rear wheels 7 move up and down in opposed directions to each other. In this case, the control seat 14 is positioned at an upper side between the right and left rear wheels 7.

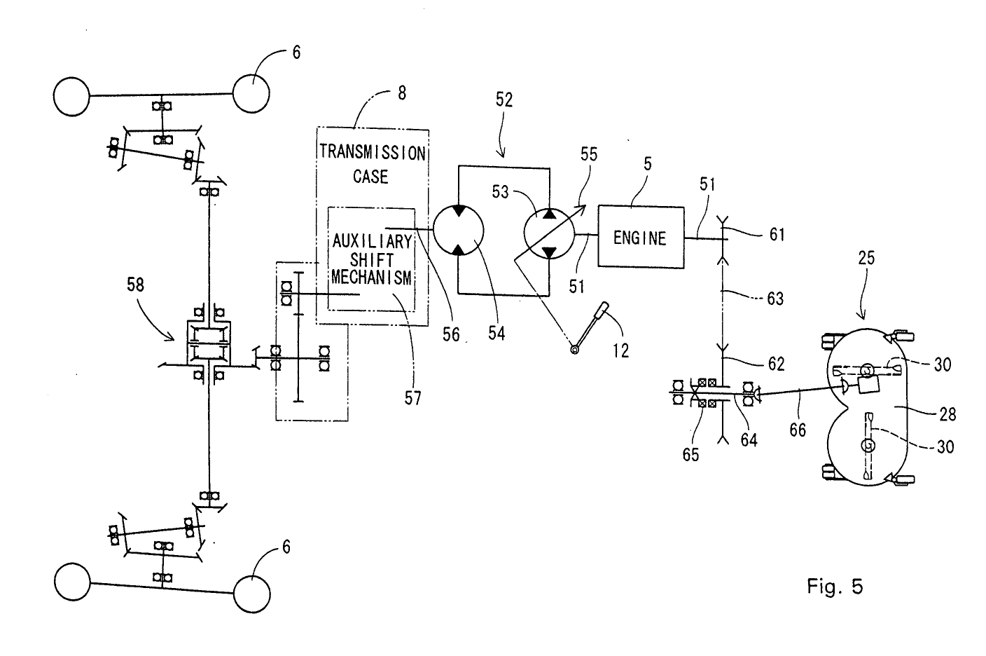

As shown in FIGS. 1 and 3, a lawn mower 25 is installed between the front wheels 6 and the rear wheels 7 in the lower portion of the vehicle body frame 2 so as to be movable up and down in a vertical direction via a link lever 26. The lawn mower 25 is provided with a pair of horizontally rotatable rotary mowing blades 30 within a downward open bowl shaped mower case 28 (refer to FIG. 5). A grass collecting box 27 is provided in the rear portion of the vehicle body frame 2. A discharge duct 29 for discharging the mowed grass is extended backward from an upper surface side of the mower case 28, and the discharge duct 29 is communicated with the grass collecting box 27. The mowed grass mowed by the rotary mowing blade 30 is discharged to the grass collecting box 27 from the discharge duct 29 by a carrier wind which is generated by the rotation of the rotary mowing blade 30.

A front loader 31 is provided in the front portion of the vehicle body frame 2. The front loader 31 has loader posts 32 which are arranged in both right and left sides with respect to the hood 9, a pair of right and left lift arms 33 each of which is connected to an upper end of each of the loader posts 32 so as to freely oscillate up and down, and a bucket 34 which is connected to leading end portions of the right and left lift arms 33 so as to freely oscillate up and down.

A lift cylinder 36 for oscillating the lift arm 33 up and down is provided between each of the loader posts 32 and the corresponding lift arm 33. A bucket cylinder 38 for oscillating the bucket 34 up and down is provided between a transverse frame 37 connecting between longitudinal middle portions of the right and left lift arms 33, and the bucket 34. In this case, the lift cylinder 36 and the bucket cylinder 38 are actuated so as to expand and contract on the basis of an operation of a loader lever (not shown) by an operator of the control seat 14, thereby oscillating the lift arm 33 and the bucket 34 up and down.

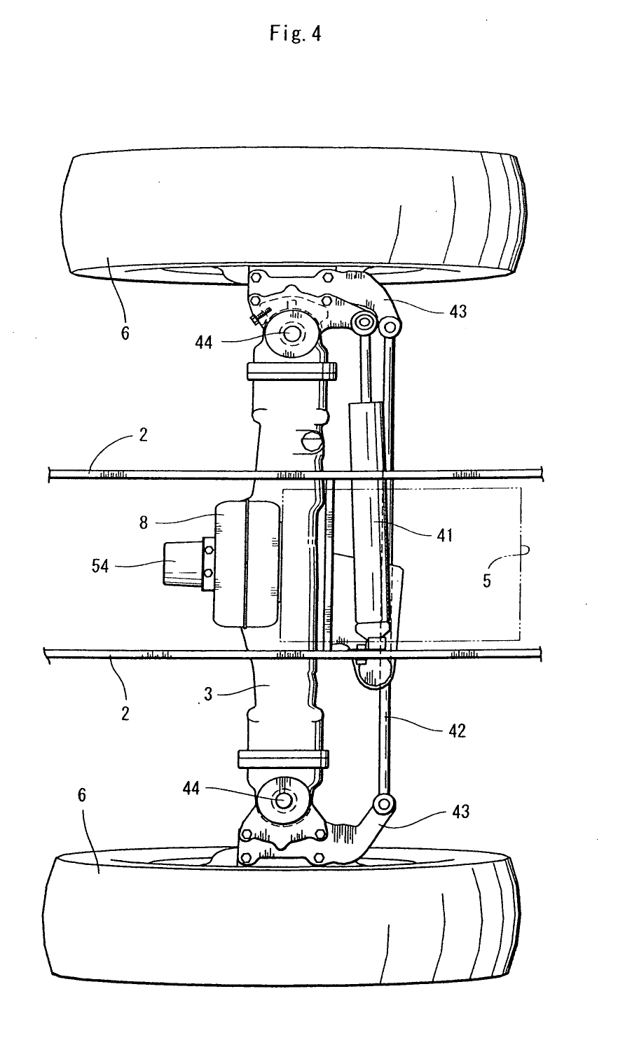

Further, as shown in FIG. 4, a steering hydraulic cylinder 41 for diverting the right and left front wheels 6 is provided. The steering hydraulic cylinder 41 is actuated so as to expand and contract in proportion to an amount of rotating operation in the right and left direction of the control handle 11, and is structured such as to divert the right and left front wheels 6 around a king pin 44 via a tie rod 42 and a knuckle arm 43 and change a course of the tractor 1. In this case, the steering hydraulic cylinder 41 is supported to the front axle case 3. Further, the front axle case 3, the engine 5, and the transmission case 8 are fixedly supported to the vehicle body frame 2.

Further, as shown in FIG. 5, a shifting hydraulic pump 53 of a hydraulic variable transmission 52 is coupled to an output shaft 51 (a crank shaft) which is protruded to a forward side direction of the engine 5. A shifting hydraulic motor 54 of the hydraulic variable transmission 52 is connected to the shifting hydraulic pump 53 via a closed loop hydraulic circuit. The main shift lever 12 is coupled to a swash plate 55 of the shifting hydraulic pump 53. A gear type auxiliary transmission mechanism 57 within the transmission case 8 is coupled to a shift output shaft 56 of the shifting hydraulic motor 54. The shift output shaft 56 is coupled to a differential gear mechanism 58 within the front axle case 3 via the gear type auxiliary transmission mechanism 57.

In other words, a driving force is transmitted to the right and left front wheels 6 from the output shaft 51 of the engine 5 via the hydraulic variable transmission 52, the gear type auxiliary transmission mechanism 57, and the differential gear mechanism 58, thereby the tractor 1 moves forward or backward. A rotating speed of the shift output shaft 56 is continuously changed on the basis of an operation of the main shift lever 12, and a rotating speed of the gear type auxiliary transmission mechanism 57 is changed in multiple stages on the basis of the operation of the auxiliary shift lever 13.

Further, as shown in FIG. 5, a PTO shaft 64 is coupled to the output shaft 51 (the crank shaft) which is protruded to the rear side direction of the engine 5, via pulleys 61 and 62 and a belt 63. The structure is made such that the driving force of the engine 5 is transmitted to the PTO shaft 64 on the basis of a turn-on operation of a PTO clutch 65 provided on the PTO shaft 64. The rotary mowing blade 30 of the lawn mower 25 is coupled to the PTO shaft 64 via a mower drive shaft 66. In other words, the rotary mowing blade 30 is actuated so as to fixedly rotate on the basis of a rotational power of the engine 5, and mows a lawn grass or the like so as to collect in the grass collecting box 27.

As shown in FIGS. 1 to 5, in the working vehicle in which the lawn mower 25 or the front loader 31 serving as the ground working machine is installed to the vehicle body frame 2 serving as the traveling machine body which is supported by the front wheels 6 and the rear wheels 7 so as to freely travel, since the structure is made such that the transmission case 8 serving as the transmission is arranged in the front portion of the traveling machine body 2 to which the engine 5 serving as the prime mover is mounted, whereby the power of the engine 5 is transmitted to the front wheels 6 via the transmission case 8, it is possible to maintain a ground pressure of the front wheels 6 by a weight of the front portion of the vehicle body frame 2, and it is possible to easily secure a movement propelling force of the front wheels 6. It is possible to easily achieve an improvement of a traveling stability, a reduction of a manufacturing cost, an improvement of a shift performance, a reservation of a lift space of the lawn mower (a mid mount ground working machine) 25, and the like.

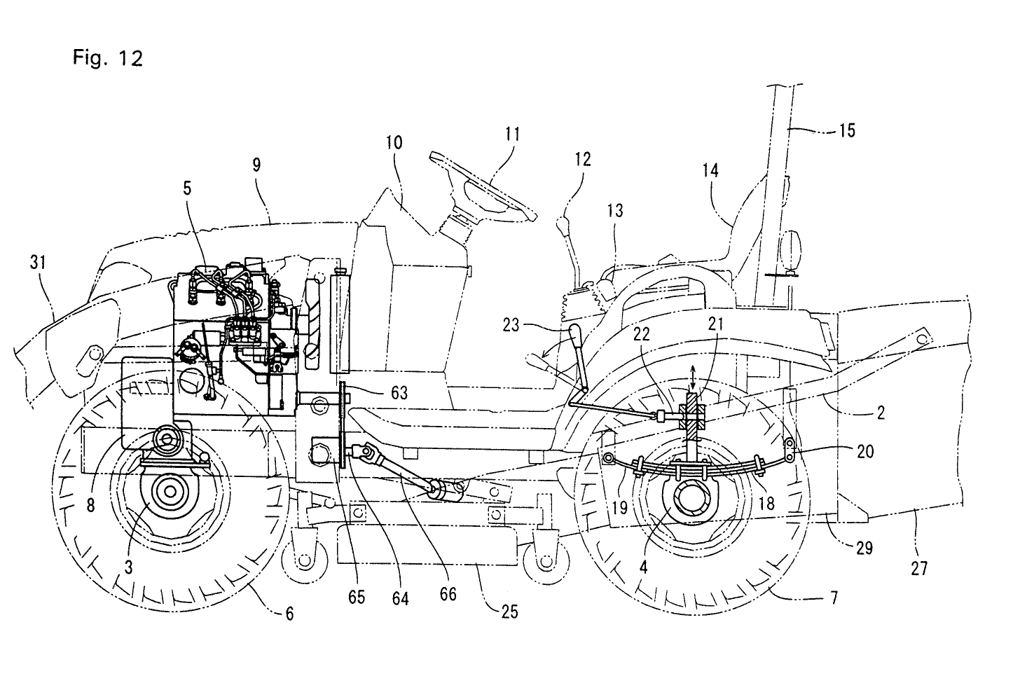

Further, FIG. 12 is a side explanatory view showing a modified structure of FIG. 3, and right and left suspension lead spring bodies 18 are provided in place of the rolling shaft 16 shown in FIG. 3. One end sides of the right and left suspension leaf spring bodies 18 are coupled to the vehicle body frame 2 via a coupling shaft 19. The other end sides of the right and left suspension leaf spring bodies 18 are coupled to the vehicle body frame 2 via a coupling link 20. Both right and left end portions of the rear axle case 4 are fastened to intermediate portions of the right and left suspension leaf spring bodies 18. The right and left rear wheels 7 are moved up and down on the basis of a deformation of the right and left suspension leaf spring bodies 18.

On the other hand, an elevating guide body 21 is provided in a rising manner in an upper surface of the rear axle case 4. The vehicle body frame 2 is provided with a lock pin body 22 which locks and unlocks the elevating guide body 21. In the case that the elevating guide body 21 is locked to the vehicle body frame 2 on the basis of an operation of a lock lever 23, the rear axle case 4 is integrally fixed to the vehicle body frame 2, and a heavy load ground work can be carried out in a state in which an attitude of the tractor 1 is stabilized, in the work of the front loader 31. In the case that the elevating guide body 21 is unlocked from the vehicle body frame 2 on the basis of the operation of the lock lever 23, the rear axle case 4 freely moves up and down with respect to the vehicle body frame 2, and it is possible to travel on a very bumpy road surface, in the work of the lawn mower 25 or the like.

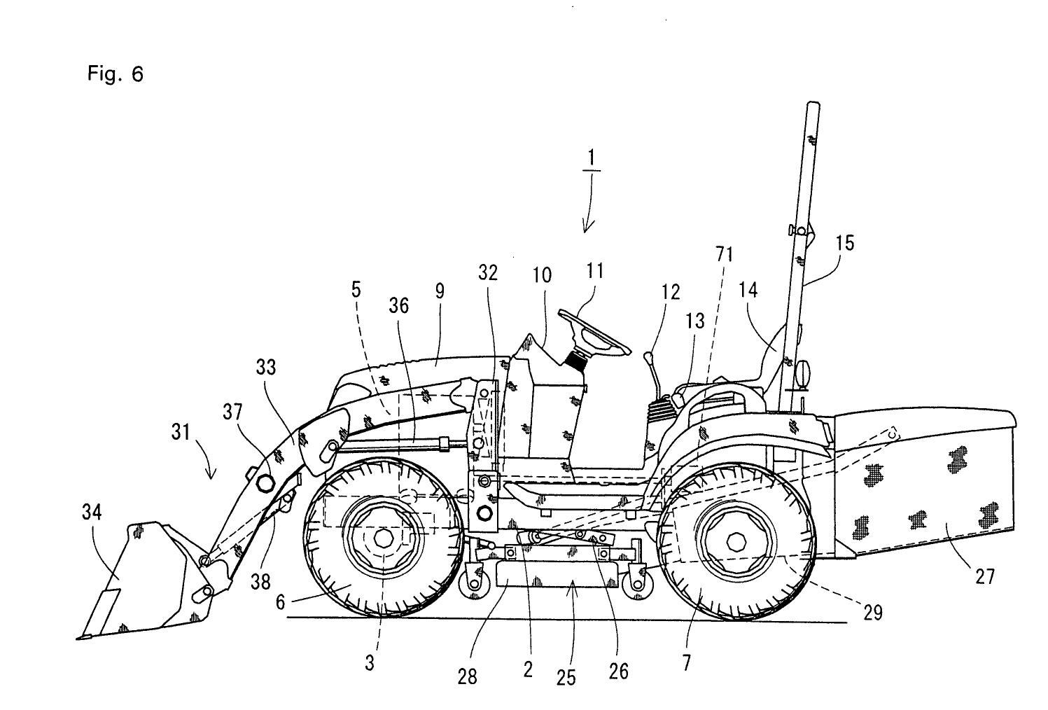

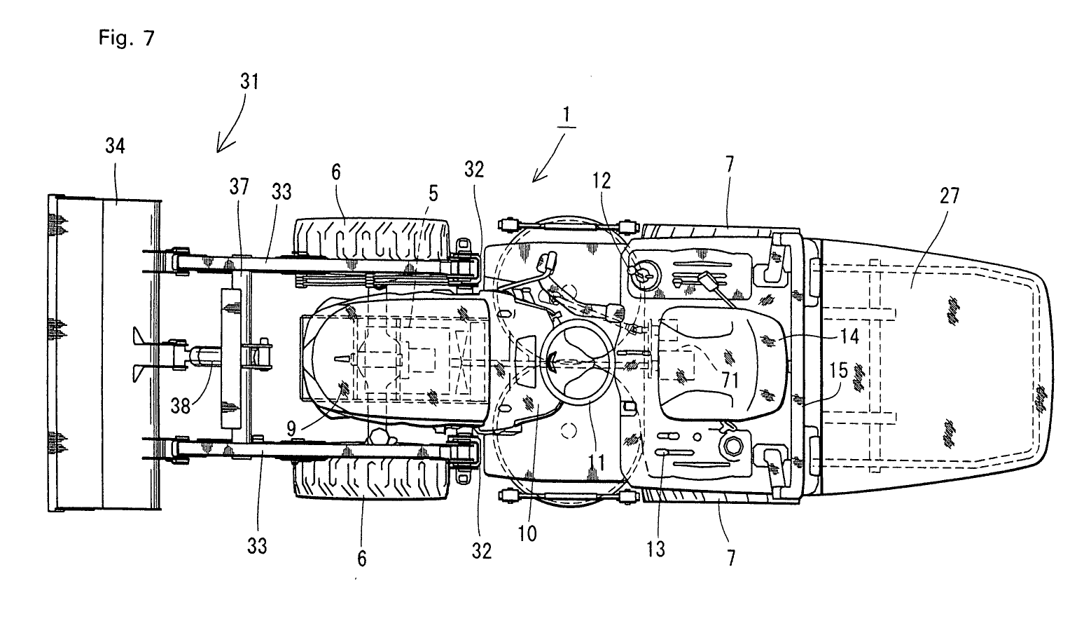

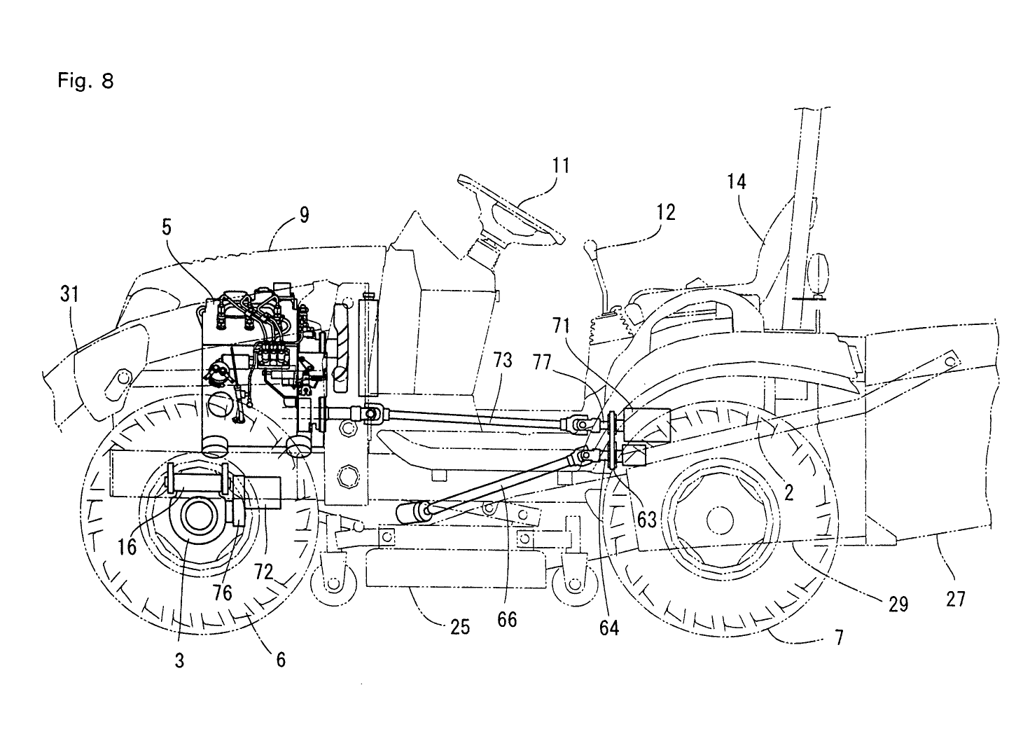

Next, a description will be given of a tractor 1 according to a second embodiment of the present invention with reference to FIGS. 6 to 10. FIG. 6 is a side view of an outer appearance of the tractor 1, FIG. 7 is a plan view of the same, and FIG. 8 is a front view of the same. In the same manner as the first embodiment, a pair of right and left front wheels 6 are supported to the front portion of the vehicle body frame 2 of the tractor 1 via the front axle case 3. A pair of right and left rear wheels 7 are supported to the rear portion of the vehicle body frame 2 of the tractor 1 via the rear axle case 4. The engine 5 serving as the prime mover is mounted to the front portion of the vehicle body frame 2. The engine 5 is covered by the hood 9.

Further, in the same manner as the first embodiment, the control column portion 10 having the control handle 11 is arranged in the rear portion of the upper surface of the hood 9. The control seat 14 is provided in the upper surface of the rear portion of the vehicle body frame 2. The main shift lever 12 is arranged in the left side direction of the control seat 14. The auxiliary shift lever 13 is arranged in the left side direction of the control seat 14. The lawn mower 25 is installed between the front wheels 6 and the rear wheels 7 in the lower portion of the vehicle body frame 2 so as to be movable up and down in the vertical direction via the link lever 26. The front loader 31 is provided in the front portion of the vehicle body frame 2.

Further, as shown in FIGS. 6 to 10, the transmission case 8 shown in the first embodiment 1 is omitted, and a main shifting hydraulic pump 71 and an auxiliary shifting hydraulic motor 72 are provided. The main shifting hydraulic pump 71 is mounted to a rear portion of the vehicle body frame 2 to which the discharge duct 29 is supported. The main shifting hydraulic pump 71 is coupled to the engine 5 via a universal joint shaft 73. The main shifting hydraulic pump 71 is driven by the engine 5. The main shift lever 12 is coupled to a swash plate 74 of the main shifting hydraulic pump 71. The auxiliary shift lever 13 is coupled to a swash plate 75 of the auxiliary shifting hydraulic motor 72.

Further, the gear type auxiliary transmission mechanism 57 shown in the first embodiment is omitted. The right and left front wheels 6 are coupled to a shift output shaft 56 of the auxiliary shifting hydraulic motor 72 via the differential gear mechanism 58 within the front axle case 3. In other words, the driving force from the output shaft 51 of the engine 5 is transmitted to the right and left front wheels 6 via the main shifting hydraulic pump 71, the auxiliary shifting hydraulic motor 72, and the differential gear mechanism 58, thereby the tractor 1 moves forward or backward. A rotating speed of the main shifting hydraulic pump 71 is continuously changed on the basis of an operation of the main shift lever 12, and a rotating speed of the auxiliary shifting hydraulic motor 72 is changed in multiple stages on the basis of the operation of the auxiliary shift lever 13.

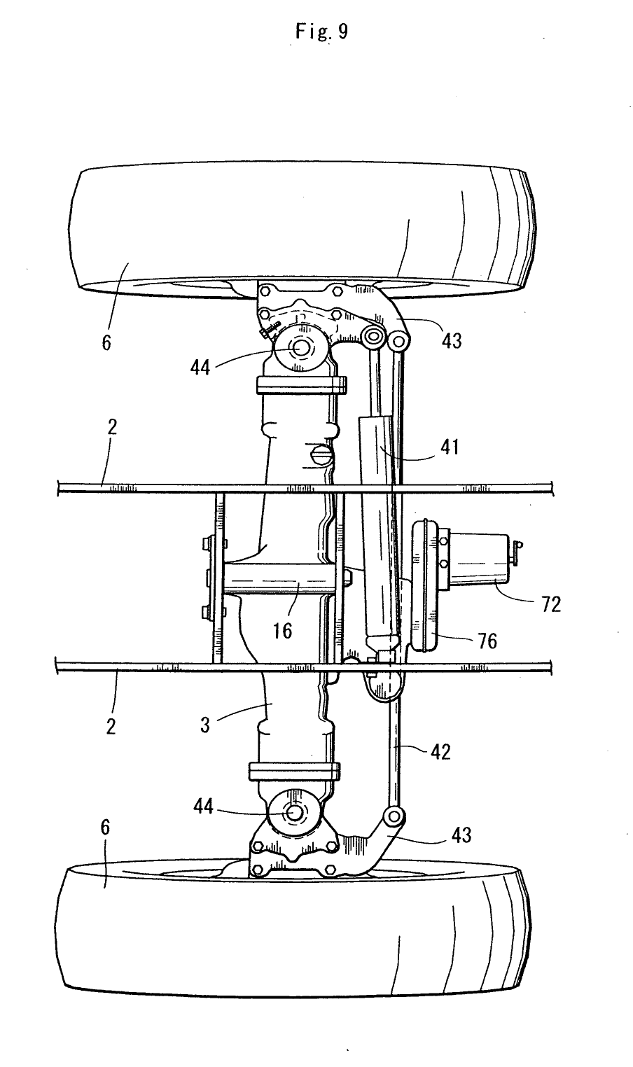

As shown in FIGS. 8 and 9, the structure is made such that a center portion of the right and left width of the front axle case 3 is connected to the vehicle body frame 2 via the rolling shaft 16, the front axle case 3 rotates around the rolling shaft 16, and the right and left front wheels 6 move up and down in opposed directions to each other. Further, the auxiliary shifting hydraulic motor 72 is firmly attached to the center portion of the right and left width of the front axle case 3 via the gear case 76.

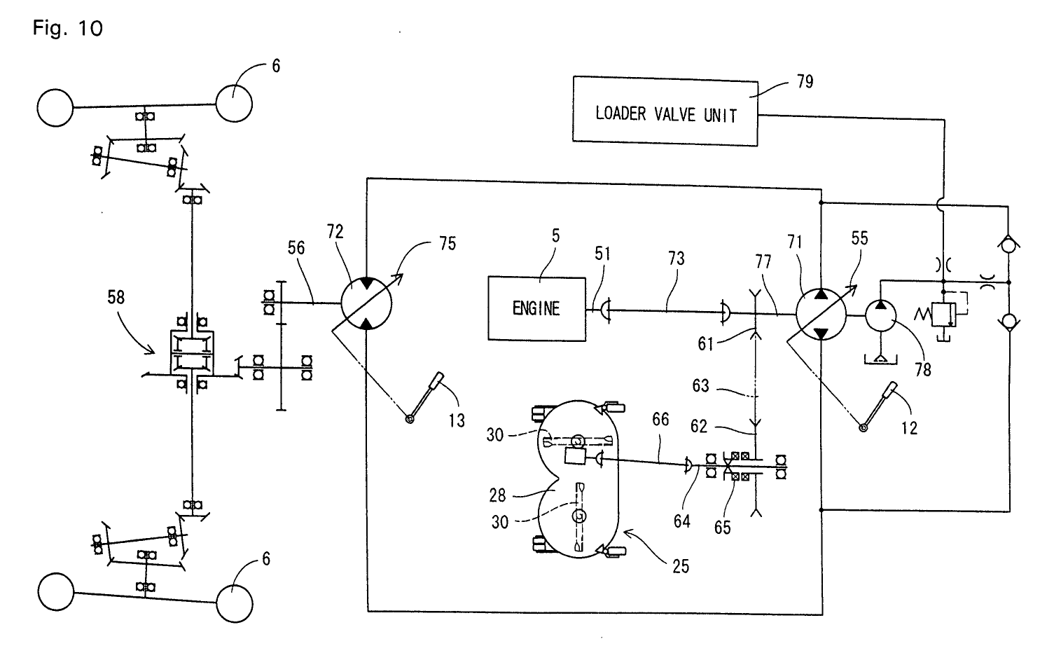

As shown in FIGS. 8 and 10, the PTO shaft 64 is coupled to an input shaft 77 of the main shifting hydraulic pump 71 via the pulleys 61 and 62 and the belt 63. The structure is made such that the driving force of the engine 5 is transmitted to the PTO shaft 64 on the basis of a turn-on operation of the PTO clutch 65 provided on the PTO shaft 64. The rotary mowing blade 30 of the lawn mower 25 is coupled to the PTO shaft 64 via the mower drive shaft 66. In this case, a charge pump 78 is provided on the input shaft 77, thereby structuring such that a high-pressure oil is supplied from the charge pump 78 to a loader valve unit 79 for actuating the front loader 31.

As shown in FIGS. 1 and 6, since the engine 5 serving as the prime mover is mounted to the front portion of the vehicle body frame 2, it is possible to achieve a compact structure of the driving portion and a cost reduction by directly connecting the transmission case 8 to the engine 5, as shown in FIG. 1. Further, as shown in FIG. 6, it is possible to maintain a balance between the front and rear of the machine body, by mounting the main shifting hydraulic pump 71 serving as the traveling hydraulic pump to the rear portion of the vehicle body frame 2.

As shown in FIGS. 8 to 10, since the structure is made such that the main shifting hydraulic pump 71 and the auxiliary shifting hydraulic motor 72 which serve as the transmission are provided, the main shifting hydraulic pump 71 is arranged in the vehicle body frame 2, the auxiliary shifting hydraulic motor 72 is arranged in the front axle case 3 to which the front wheels 6 are supported, and the front wheels 6 steered by the control handle 11 is driven by the auxiliary shifting hydraulic motor 72, it is possible to compactly install the auxiliary shifting hydraulic motor 72 by utilizing the front axle case 3.

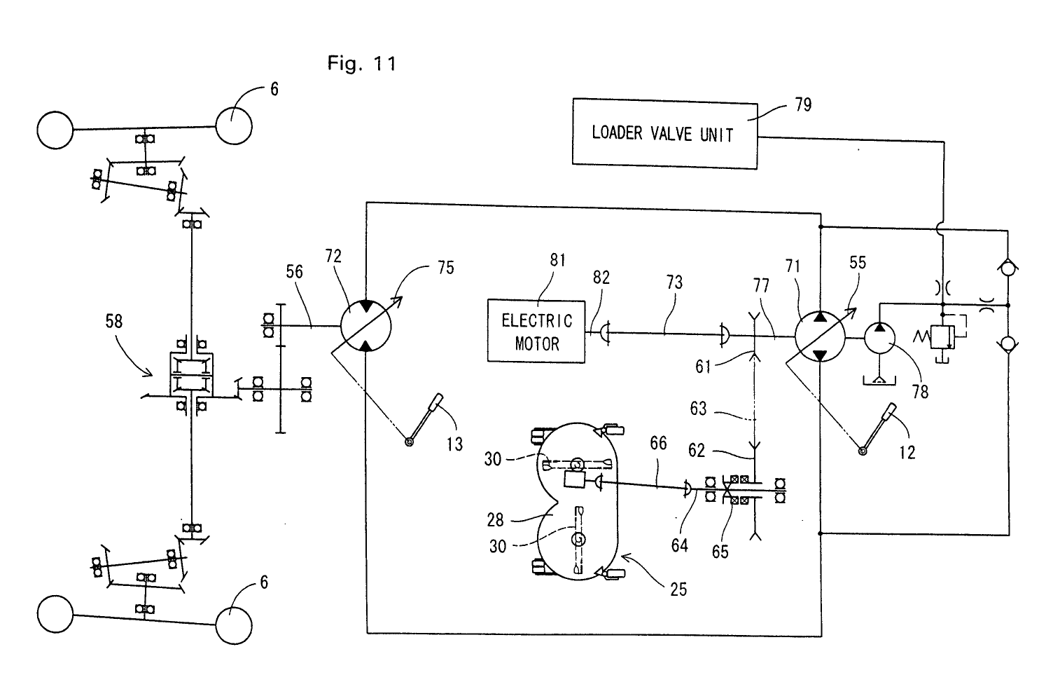

Next, a description will be given of a tractor 1 according to a third embodiment of the present invention with reference to FIG. 11. In place of the engine 5 according to the second embodiment, an electric motor 81 serving as the prime mover is provided. The main shifting hydraulic pump 71 is coupled to an output shaft 82 of the electric motor 81 via the universal joint shaft 73. In the same manner as the second embodiment, the structure is made such as to actuate the front wheels 6 and the lawn mower 25 or the front loader 31 on the basis of a rotational driving force of the electric motor 81.

As shown in FIGS. 10 and 11, since there are provided with the main shift lever 12 serving as the main shift operation device mainly shift controlling the main shifting hydraulic pump 71, and the auxiliary shift lever 13 serving as the auxiliary shift operation device accessorily shift controlling the auxiliary shifting hydraulic motor 72, it is possible to simply achieve a reduction of a manufacturing cost, an improvement of a shift performance and the like. It is possible to easily obtain a moving speed which is suitable for various ground works.

As shown in FIG. 11, since the electric motor 81 serving as the prime mover is mounted to the front portion of the vehicle body frame 2, it is possible to achieve a compact structure of the driving portion and the cost reduction by directly connecting the main shifting hydraulic pump 71 to the electric motor 81. An exhaust gas emission controls or the like is not necessary, and it is possible to easily achieve a weight saving or the like. It is possible to drive the front wheels 6, or the lawn mower 25 or the front loader 31 with a low noise and a low pollution, by using the electric motor 81 as a driving source. It can be made good use for a front loader work in a barn.

What is claimed is:

1. A working vehicle comprising:
a ground working machine being installed to a traveling machine body which is supported by front wheels and rear wheels so as to freely travel,
wherein a transmission is arranged in a front portion of the traveling machine body by which a prime mover is mounted, whereby a power of the prime mover is transmitted to the front wheels via the transmission.

2. The working vehicle according to claim 1, wherein an engine serving as the prime mover is mounted to the front portion of the traveling machine body.

3. The working vehicle according to claim 1, further comprising:
a traveling hydraulic pump and a traveling hydraulic motor which serve as the transmission,
wherein the traveling hydraulic pump is arranged in the traveling machine body, the traveling hydraulic motor is arranged in a front axle case to which the front wheels are supported, and the front wheels steered by a control handle is driven by the traveling hydraulic motor.

4. The working vehicle according to claim 1, further comprising:
a main shift operation device mainly shift controlling the traveling hydraulic pump; and
an auxiliary shift operation device accessorily shift controlling the traveling hydraulic motor.

5. The working vehicle according to claim 1, wherein an electric motor serving as the prime mover is mounted to the front portion of the traveling machine body.
